(19) United States
(12) Patent Application Publication
(10) Pub. No.: US 2006/0062399 A1
(43) Pub. Date: Mar. 23, 2006

(54) Band-limited polarity detection

(76) Inventors: Joel C. McKee Cooper, Lafayette, CO (US); Noritoshi Noso, Yokohama-shi (JP)

Correspondence Address: Robert P. Bell, 8033 Washington Road, Alexandria, VA, 22308, US

(21) Appl. No.: 11/061,736

(22) Filed: Feb. 22, 2005

Related U.S. Application Data
(63) Continuation-in-part of application No. 11/002,102, filed on Dec. 3, 2004.
(63) Continuation-in-part of application No. 11/038,577, filed on Jan. 21, 2005.
(60) Provisional application No. 60/612,474, filed on Sep. 23, 2004.

(51) Int. Cl. H04R 29/00

(52) U.S. Cl. 381/58; 381/59

(57) ABSTRACT

Individual speaker polarity is detected by band-limiting the processing to a range where the impulse response of most speakers are in-phase with their wiring. In the preferred embodiment, a second order 400 Hz Low Pass Filter (LPF) is used to band-limit the processing. Filtering can occur prior to processing as part of the noise generation, or completely as a post-processing operation on a full-bandwidth impulse response. Applying the low pass filter eliminates artifacts in the impulse response due to reverse-polarity wired drivers in a speaker system (e.g., tweeter). By analyzing only the lower frequencies, the initial peak of the impulse response will correlate to speaker polarity in the system.

### CROSS-REFERENCE TO RELATED APPLICATIONS

The present application claims priority from Provisional U.S. Patent Application No. 60/612,474 filed on Sep. 23, 2004 (Cirrus Logic Docket No. 1537-DSP), and incorporated herein by reference. The present application is also a Continuation-In-Part of U.S. patent application Ser. No. 11/002,102 entitled “TECHNIQUE FOR SUBWOOFER DISTANCE MEASUREMENT”, filed on Dec. 3, 2004 (Cirrus Logic Docket No. 1538-DSP), and incorporated herein by reference. The present application is also a Continuation-In-Part of U.S. patent application Ser. No. 11/038,577, filed on Jan. 21, 2005 (Cirrus Logic Docket No. 1539-DSP), and incorporated herein by reference. The present application is also a Continuation-In-Part of U.S. patent application Ser. No. UNASSIGNED filed on Feb. 14, 2005 (Cirrus Logic Docket No. 1540-DSP), and incorporated herein by reference.

### FIELD OF THE INVENTION

The present invention relates to a method and apparatus for calibrating a home theater system. In particular, the present invention is directed toward a technique for determining the polarity of speaker wiring to ensure that the speakers have been properly hooked up.

### BACKGROUND OF THE INVENTION

Home theater systems, which once were expensive luxury items, are now becoming commonplace entertainment devices. Complete Home. Theater systems, known as a Home Theater In a Box (HTIB), are available to consumers at reasonable prices. However, properly setting up such Home Theater systems can sometimes be problematic for the consumer.

Home theater systems provide a number of components, which may be located in various parts of the room. The components include the home theater receiver/amplifier, front stereo speakers (left and right), rear surround sound speakers (left and right), a center speaker, and a subwoofer. Various other combinations of speakers may also be used, including additional or fewer speakers. One such home theater system is described, for example, in U.S. Pat. No. 5,930,370, issued Jul. 27, 1999 to Ruzicka, incorporated herein by reference. Another such home theater system is disclosed in Published U.S. patent application 2004/0258259, published Dec. 23, 2004 to Koyama, (hereinafter “Koyama”) and incorporated herein by reference.

FIG. 2 is a block diagram of a Prior Art Home Theater system as taught by Koyama. In the Home Theater System 100, an operation unit 110 for executing a volume operation, an input switching, or the like is provided on a front panel. The Home Theater System 100 has: a display unit 111 for displaying various setting contents or the like of the Home Theater System 100; and a setting operation unit 112 for performing various setups. The display unit 111 has, for example, one to a few lines on each of which a few to ten and a few characters can be displayed.

Home Theater System 100 may be compatible with the 5.1 ch surround sound system and six speakers FL, FR, C, SL, SR, and SW may be connected. Speakers FL and FR are the left and right front speakers. Speaker C is the center speaker. Speakers SL and SR are the left and right surround speakers. Speaker SW is the sub woofer speaker.

DVD (Digital Versatile Disc) player 102 may be connected as an AV reproducing apparatus to the Home Theater System 100. A video monitor apparatus 101 may be connected to Home Theater System 100. A video signal reproduced by DVD player 102 may be supplied to video monitor apparatus 101 through Home Theater System 100 and displayed on a display screen. An audio signal reproduced by DVD player 102 may be supplied to Home Theater System 100, subjected to predetermined processes, and supplied to the connected speakers FL, FR, C, SL, SR, and SW, so that audio sounds are generated. By properly arranging the speakers FL, FR, C, SL, SR, and SW, the user can enjoy surround sound.

In such a system, to comfortably enjoy surround sound, the user needs to setup the Home Theater System 100 in accordance with the construction (layout, connecting form, and the like) of the speakers FL, FR, C, SL, SR, and SW. Home Theater System 100 may have a memory therein and speaker settings according to combination patterns of the speakers that can be constructed have previously been stored in the memory. Prior to performing the speaker setup to Home Theater System 100, the user needs to recognize which one of the patterns previously registered in Home Theater System 100 correspond to the speaker construction of his own system or recognize which pattern his own speaker construction is close to. By operating the setting operation unit 112 on the basis of contents displayed on the display unit 111, the user can select the option which best describes the speaker construction of his own system from the patterns stored in the memory and perform the speaker setup.

A 5.1 ch system is constructed by connecting the left and right front speakers FL and FR, the center speaker C, the left and right surround speakers SL and SR, and the sub woofer SW. A 5.1 ch system may be also used without connecting all of those speakers. In this case, the signals in the channels to which the non-connected speakers correspond are ignored or the acoustic sounds of the non-connected speakers are compensated for using the connected speakers by acoustic processes in the Home Theater System 100.

One problem with such systems is they may require the consumer to unpack the various components of the system, place the components in optimal positions around the room, and then wire the components together. Speakers have traditionally been connected to the main module via speaker wire, which may be marked, using a number of techniques, for polarity. The amplifier or receiver unit may have wire connectors color-coded (e.g., red and black) and the speakers may have similar wire connectors with similar color-coding. This color-coded is needed to ensure that the speakers are all connected using the same polarity. If one speaker in the system is connected using a reverse polarity, it may generate sound out of phase with the other speakers, causing degradation in the sound reproduction or other audio artifacts.

Unfortunately, the wires often used for speaker wire are marked in a manner that can be difficult to read. A thin stripe, faintly painted onto the speaker wire insulation, may indicate which wire is supposed to be the “positive” polarity wire. Alternatively, one of the pair of wires may have a slight ridge or embossment on the insulation to indicate polarity. Some wires utilize different materials (aluminum and copper) in a transparent or translucent sheathing.

All of these Prior Art approaches have limitations. The printed or embossed indicia are often difficult to discern for a consumer and can be readily reversed without much effort. The use of different wire materials (copper and aluminum, for example) creates leads with different resistance levels. In all situations, however, the main problem is that the consumer can easily forget which lead was selected as the “positive” (or “red”) lead of the speaker wire pair, and thus end up connecting some speakers in one polarity and other speakers in a different polarity.

One solution to this problem is to provide a dedicated plug for the speaker connections such that the consumer need only plug the system together, and thus polarity problems are eliminated. Many lower cost stereo systems of the Prior Art attempted this approach using so-called “RCA” jacks to connect stereo speakers to a receiver unit. The problem with this approach is that for higher-powered systems, such connections may be inadequate, as larger gauge speaker wire may be needed than the thin coaxial cables provided with such RCA-type connections. In addition, if a user needs to locate a speaker at a distance further away from the receiver than the length of the supplied cable, the user must purchase an extension cable with the correct fittings on each end. Moreover, the market preference has been for traditional speaker pair wiring, as it is viewed as more professional grade by consumers than RCA jack wiring.

One Prior Art approach for high-end home theater systems has been to hire a skilled acoustician to setup the home theater system. Such a skilled technician can adjust the location and placement of the speakers, and using various components, (adjustable delays, equalizers, and even passive acoustical components), optimize the sound quality for a particular room, and ensure that all components are connected in the correct polarity. Unfortunately, hiring an acoustician to fine tune a home theater system is expensive. Many “consumer grade” home theater systems sell for only a few hundred dollars, which is far less than the cost of even one in-home visit by an acoustician.

A recent trend in Home Theater systems has been to provide automatic setup and calibration features, so that a consumer can optimize the sound of the system to compensate for speaker placement, room acoustics, and speaker/room interaction. These setup modes can adjust the time delay in the system, as well as optimize the equalization setup of the system. Some of these systems can detect whether left and right speakers are out-of-phase with each other, but not whether individual speakers are wired with the correct polarity. Most of the automatic setup systems operate by placing a microphone in the room, and then measuring the system response of the Home Theater system.

Thus, many Home Theater systems are already provided with a built-in system for measuring the relative time delay (e.g., location) of speakers within a room, as well as equalization levels, using a microphone and some processing equipment so that a consumer can calibrate the system for a given room. Such a system has many advantages, as it reduces the overall cost of installation, provides a better acoustical response to the system (resulting in fewer consumer complaints) and also allows the system to be easily moved to new locations.

While a number of such systems exist in the present market, one such system is illustrated, for example, by U.S. Pat. No. 6,655,212, issued on Dec. 2, 2003 to Ohta (hereafter “Ohta”), and incorporated herein by reference. FIG. 1 is a diagram from Ohta, illustrating a configuration of a measurement system including the sound field measuring apparatus. Measurement system 100 comprises a number of components. DSP (Digital Signal Processor) 1 outputs a test signal to D/A converters 2a, 2b, etc. Amplifiers 3a, 3b, etc. receive signals output from D/A converters 2a, 2b, etc. and drive speakers 4a, 4b, etc. Microphone 6 is disposed at a predetermined position (listening position) in an acoustic space 5 where the speakers 4a, 4b, etc. are placed. Amplifier 7 amplifies a signal output from microphone 6 and outputs the signal to A/D converter 8.

DSP 1 includes a number of components. Exponential pulse generator 11 generates an output signal to speaker (“SP”) selector 12, which in turn outputs the signal to a selected one (or more) of D/A converters 2a, 2b, etc. RAM 14 stores a received signal from A/D converter 8. Calculation section 15 uses the data stored in RAM 14 to calculate the time of arrival of an exponential pulse transmitted via speaker 4a, 4b, etc. Control section 13 operates exponential pulse generator 11 and RAM 14 so as to synchronize start timings. Calculation section 15 includes a rising emphasizing section 151, a time detecting section 152, and a calculating section 153.

Although not shown, DSP 1 has a signal processing circuit, which, during multi-channel audio reproduction using speakers 4a, 4b, etc., to delay each channel's signal by a predetermined time period. According to this configuration, the perceived distances between the speakers and the listening position can be made constant by adjusting the time delays to compensate for the actual differences in distance.

In operation, a system such as that illustrated in FIG. 1 may send a signal generated by exponential pulse generator 11 (or other sound source) to a speaker 3a, 3b, etc. via speaker selector 12. Microphone 6 maybe positioned by a consumer at a preferred listening location in the room. Microphone 6 receives the exponential pulse (or other sound) from speaker 3a, 3b, etc. and transmits this signal, via amplifier 7 and A/D converter 8 to RAM 14. Calculating section 15 may then measure the time delay between the output of the sound pulse from speaker 4a, 4b, etc. and the reception at microphone 6, and thus calculate the relative distance of the speaker from the preferred listening position. This value may be displayed to the user as a physical distance, and/or may be used as a time delay value internally. Each speaker 4a, 4b, etc. is tested in turn, and relative time delays are calculated. The home theater system can then adjust the relative time delays of each speaker accordingly to provide optimal sound levels at the preferred listening area.

Prior Art home theater and stereo systems are known in the art that will report the relative polarity of speaker pair wiring. However, such systems report only whether left and right speaker pairs are wired with the same polarity. This reporting may be done in a variety of ways. One known technique is to compare the impulse responses from each speaker and see if the initial peak is in the same direction. Systems known in the art which report wiring problems on a per-speaker basis also exist, but such systems are often inaccurate and do not work for all types of speakers, as they do not compensate for the internal wiring of some speakers, which may have the tweeter wired backward from the woofer.

It is common practice in two-way loudspeaker systems for the tweeter to be wired out-of-phase from the woofer, to compensate for phase response of the internal loudspeaker crossover network. This practice results in the initial peak of the overall impulse response to have the opposite polarity of the speaker wiring. For the purposes of this application, the terms “speaker” or “loudspeaker” and a “driver” have different meanings. A speaker or loudspeaker refers to a complete speaker, box, drivers, crossover, grill, and the like. A driver is defined as the individual sound producing elements in the speaker, e.g., woofer, tweeter, midrange, and the like. Thus, when referring to speaker polarity or loudspeaker polarity in the present invention, the reference is to the polarity of the connection to the overall loudspeaker box, and not to the individual drivers within.

Thus, it remains a requirement in the art to provide a method for detecting whether an individual loudspeaker is correctly wired with regard to system polarity, such that the polarity of all speakers in a system can be correctly determined, not only relative to each other, but to the system itself.

### SUMMARY OF THE INVENTION

The present invention properly detects individual speaker polarity by band-limiting the processing to a range where the impulse response of the system is in-phase with the polarity of the loudspeaker wiring.

In the preferred embodiment, a second order 400 Hz Low Pass Filter (LPF) is used to band-limit the processing. Filtering can occur prior to processing as part of the noise generation, or completely as a post-processing operation on a full-bandwidth impulse response. Alternatively, band-limiting filters of other configurations and complexity may be used to fine-tune the phase-detection.

The impulse response may be determined using any one of a number of known Prior Art techniques. In the preferred embodiment, a novel adaptive filtering technique is used to determine impulse response. An example of this adaptive filtering technique is described in the co-pending parent Patent Applications previously incorporated by reference.

As noted in the co-pending parent Patent Applications previously incorporated by reference, an adaptive filtering system may be used to measure speaker placement, and similar hardware used to determine equalization. Thus, the speaker polarity detection system of the present invention can be added to a product containing one or more of these previous features, without any significant additional hardware cost.

### BRIEF DESCRIPTION OF THE DRAWINGS

FIG. 1 is a Prior Art diagram illustrating a configuration of a measurement system including a sound field measuring apparatus.

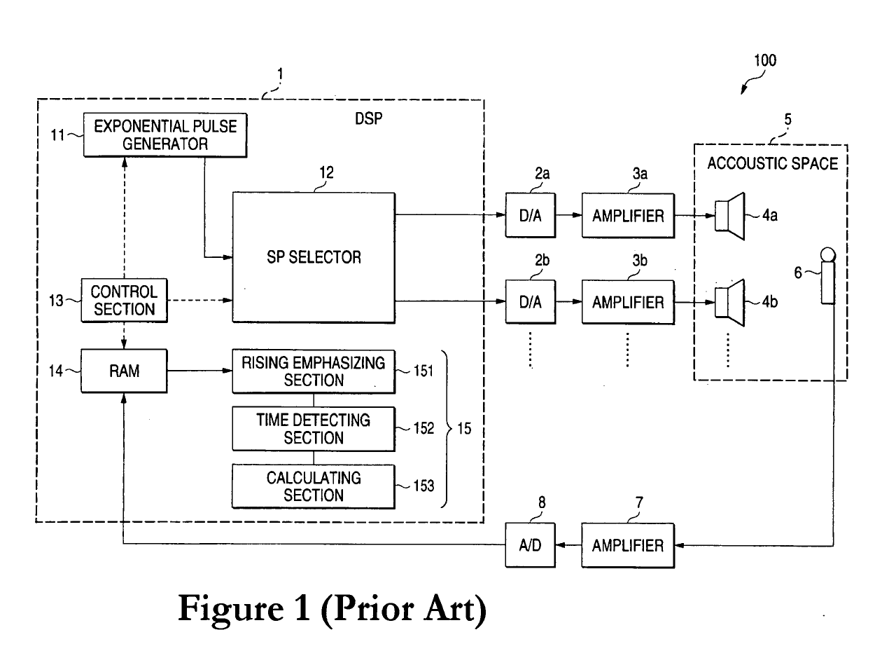

FIG. 2 is a schematic diagram showing connections of an exemplary Home Theater System.

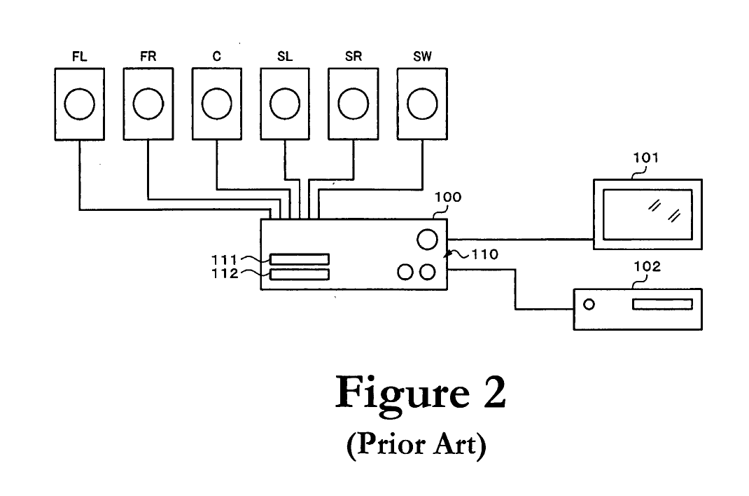

FIG. 3 is a block diagram of a speaker polarity detection system of a first embodiment of the present invention.

FIG. 4 is a block diagram of a speaker polarity detection system of a second embodiment of the present invention.

FIG. 5 is a graph illustrating the impulse response for a hypothetical ideal system with completely flat magnitude response and zero delay, where the loudspeaker is connected with proper polarity.

FIG. 6 is a graph illustrating the impulse response for a hypothetical ideal system with completely flat magnitude response and zero delay where the loudspeaker is connected with reverse polarity.

FIG. 7 is a graph illustrating the impulse response for a hypothetical ideal system with completely flat magnitude response, where the loudspeaker is connected with proper polarity and a delay is present in the system.

FIG. 8 is a graph illustrating impulse response for a “real” system.

### DETAILED DESCRIPTION OF THE INVENTION

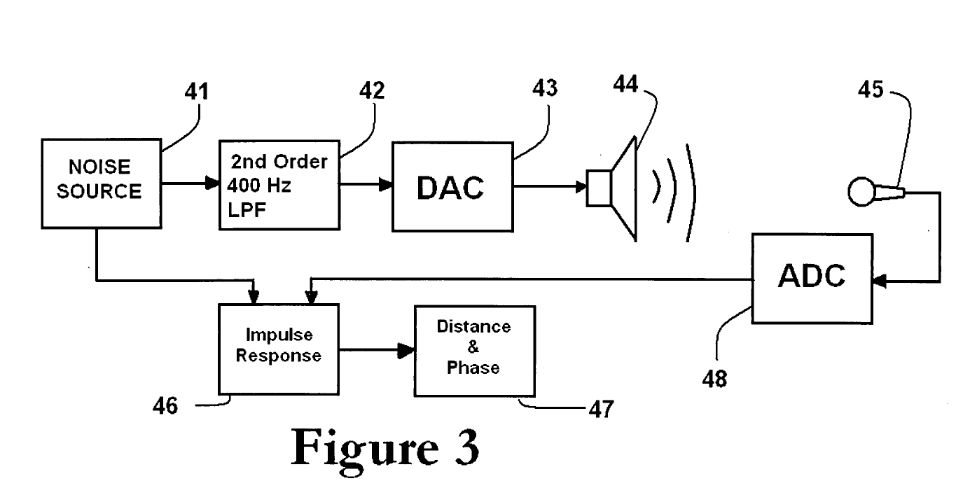

FIG. 3 is a block diagram of the apparatus of the present invention employing an adaptive filter for polarity detection. For the sake of simplicity, many of the basic components in an auto-setup home theater system are not illustrated here. Referring to FIG. 3, a noise source 41 may be used to generate a sound pattern or series of impulses or the like. As discussed above, this sound source could comprise a number of sound patterns generated from a stored sound pattern or generated spontaneously.

In this embodiment, the output of noise source 41 may first be passed through a second order 400 Hz low pass filter 42 to pass only those frequencies substantially below 400 Hz. A Digital to Analog Converter (DAC) 43 converts this digital sound pattern into an analog signal, which is then driven through speaker 44.

The digital signal from noise source 41 may also be sent as an input to impulse response generator 46, which in the preferred embodiment is an adaptive filter. Microphone 45, placed in the listening space, picks up the sound produced by speaker 44, which is then converted to digital form in Analog to Digital Converter (ADC) 48. The resultant digital signal is then transmitted to adaptive filter 46, which then determines the impulse response of the system. A further description of this adaptive filtering technique is set forth in co-pending U.S. patent application Ser. No. 11/038,577, filed on Jan. 21, 2005 (Cirrus Logic Docket No. tune 1539-DSP), and incorporated herein by reference. In that application, system response was used to determine speaker distance from the microphone as well as the phase response of the system.

The term “phase” may be used in the art two slightly different ways. First, the “phase of the speaker” is sometimes used to refer to the polarity of a loudspeaker, that is, which way the two wires are connected. This version of “phase” may take one of two values, either “in-phase” or “out-of-phase”. In the present application, to avoid confusion, the term “speaker polarity” will be used to describe the wiring connection to the loudspeaker. Secondly, the “phase response” of the speaker in the room is a function of frequency. The magnitude response (often inaccurately just called the “frequency response”) is the power level (Y-axis, usually in dB) plotted against frequency (X-axis in Hz).

Also, the magnitude and phase responses are really two aspects of the overall “Frequency Response” of the system. Sometimes this term “Frequency Response” may be referred to by the phrase “the magnitude and phase response”, which is a singular term instead of a plural term, as the response that contains both magnitude and phase information before they are separated into two responses

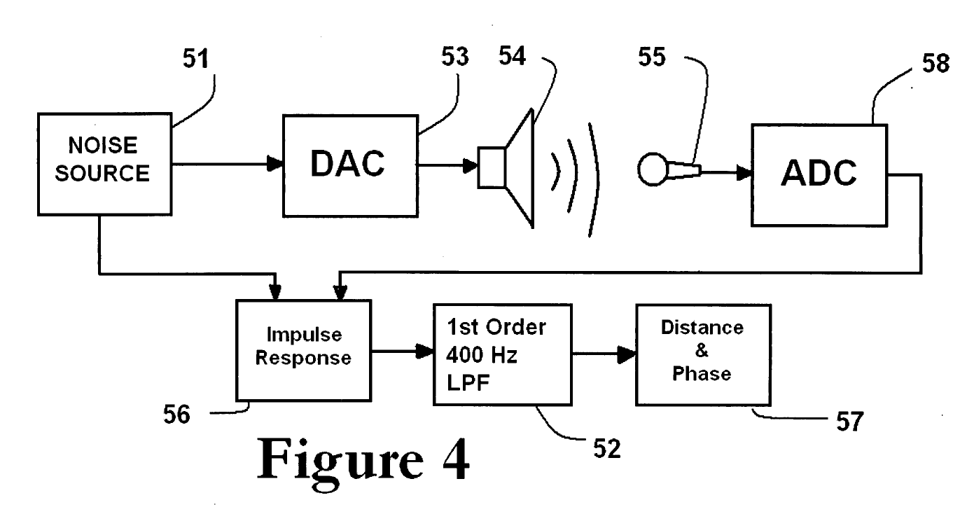

FIG. 4 is a block diagram of an alternative embodiment of the present invention employing an adaptive filter for polarity detection. For the sake of simplicity, many of the basic components in an auto-setup home theater system are not illustrated here. Referring to FIG. 4, a noise source 51 may be used to generate a sound pattern or series of impulses or the like. As discussed above, this sound source could comprise a number of sound patterns generated from a stored sound pattern or generated spontaneously.

In this embodiment, the output of noise source 51 may be sent to a Digital to Analog Converter (DAC) 53, which converts this digital sound pattern into an analog signal, which is then driven through speaker 54. The digital signal from noise source 51 may be sent as an input to impulse response generator 56, which in the preferred embodiment is an adaptive filter. Microphone 55, placed in the listening space, picks up the sound produced by speaker 54. The output of microphone 55 may be first converted to digital form in Analog to Digital Converter 58. The resultant digital signal may then be sent to adaptive filter 56, which determines impulse response of the system. The impulse response may then be filtered in second order 400 Hz Low Pass Filter 52, and from this filtered system response, the polarity of speaker 54 can then be determined as in FIG. 3.

The polarity of the speaker may be determined from the impulse response of FIG. 3 or 4 as follows. The fundamental concept behind both embodiments of FIGS. 3 and 4 is that instead of analyzing the impulse response for the entire frequency range, only a band-limited range is analyzed. When the frequency response is limited, the associated impulse response is different than that associated with the full spectrum.

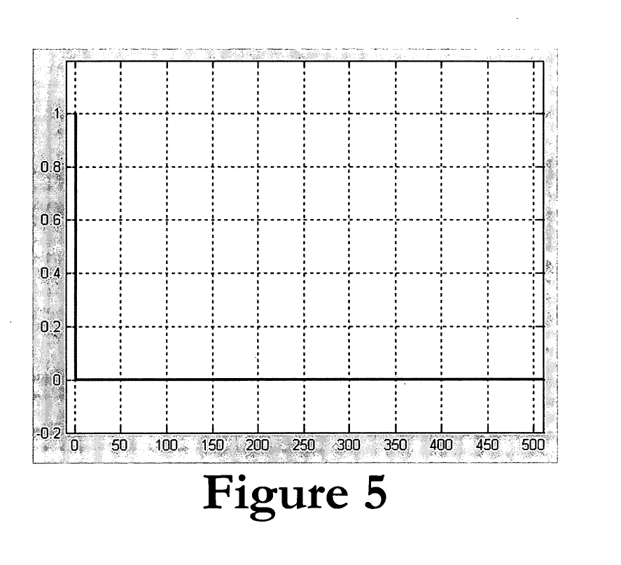

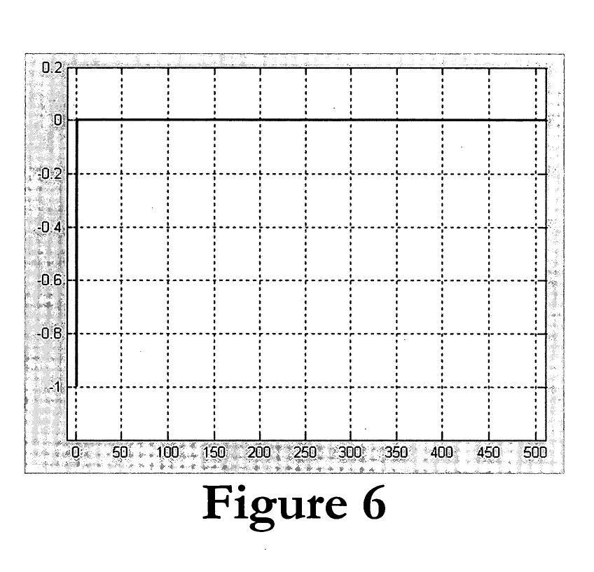

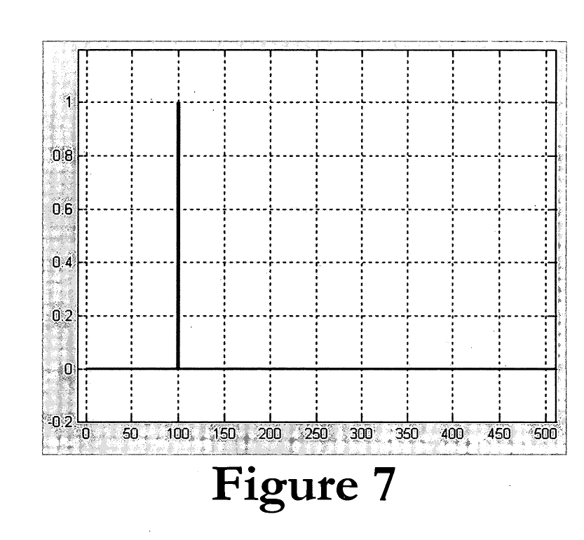

For a hypothetical ideal system with completely flat magnitude response and zero delay, the impulse response will be a perfect impulse. FIG. 5 illustrates this hypothetical perfect response as a (0,1) followed by (n,0) for all n>0, when graphed on an x,y ordinate. Given the same hypothetical “perfect” system, if the loudspeaker is hooked up backward, the impulse is inverted. FIG. 6 illustrates this hypothetical response as a (0,−1), followed by (n,0) for all n>0. If there is a delay in the system (i.e., the distance between the speaker and microphone), then the impulse is delayed accordingly. FIG. 7 illustrates this hypothetical response as m zeros followed by (m,1), followed by (n,0) for all n>m+1. The distance can be computed as (speed_of_sound*m/samplerate).

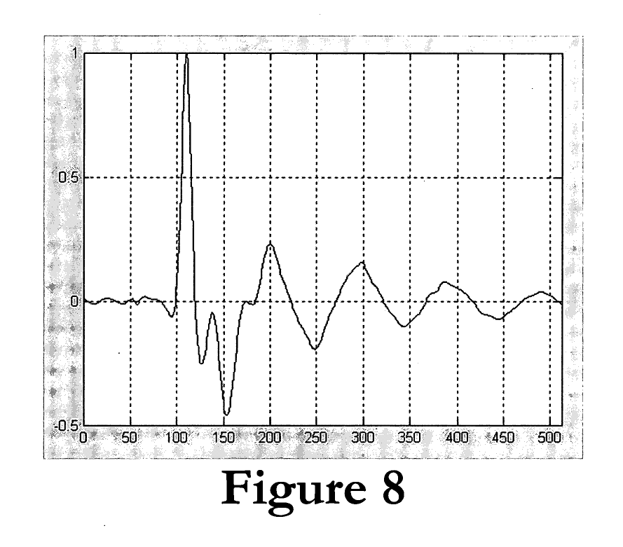

FIGS. 6-8 illustrate the response for a hypothetical ideal system. However, for a system operating in real-world conditions, the impulse response may appear more like FIG. 8. Not only is the impulse “wider” than it should be, it is not the only peak; several other pulses appear in the response profile. To determine speaker wiring polarity (for clarity the term “phase” is not used in this context), the determination could be based off the first “large” peak shown in FIG. 8. The small dip prior to 100 in the graph of FIG. 8 would be ignored.

One problem may occur when the loudspeaker comprises a 2- or 3-way loudspeaker, and not all the drivers are wired with the same polarity. The reason some driver wiring may be reversed is to compensate for phase differences introduced by the speaker crossover filter, as noted previously. This wiring is especially common in 2-way systems, where the tweeter is wired with inverse polarity, and the woofer is wired with correct polarity.

For these cases, the impulse response of the full frequency range of the speaker may have a largest, first peak that is not indicative of the wiring of the loudspeaker. This scenario is covered in the present invention by analyzing the impulse response of just the low-frequency range of the loudspeaker. As the woofer is more likely to be wired with correct polarity (inside the loudspeaker), filtering out the higher frequency ranges yields an impulse response, which more faithfully indicates overall loudspeaker polarity.

This filtering technique can be done two ways. First, as part of the test (in the preferred embodiment of FIG. 3), the noise source is passed through a low pass filter and the impulse response measured will reflect that filtering (whether by direct, MLS, LMS, whatever). A second-order 400 Hz LPF filter is used on the noise source, which may already be band-limited to 12 kHz

In a second technique, as illustrated in FIG. 4, the filtering may be performed as part of the analysis. Once the full-spectrum impulse response is determined, the impulse response can be filtered instead. The results are largely the same between the embodiments of FIGS. 4 and 5. The filtering step may take place elsewhere in the process. For example, the output of microphone 55 in FIG. 4 could be filtered, and the filtered response fed to adaptive filter 56, instead of filtering the impulse response signal.

Only one speaker is needed for polarity determination in the present invention. Thus, the present invention can determine whether each speaker in a system is properly connected, not just whether only one speaker is out of phase with respect to another speaker. As a result, the system can indicate to a user which speaker needs to have its speaker wires reversed to correct polarity problems. Once the polarity has been corrected, the user can then re-run the test, and the system indicate which remaining speakers need correction, or if indeed the previous correction was performed properly. Once all speakers have been properly connected, the system will indicate that the connections are indeed correct.

As noted previously, the present invention may be provided alone or in combination with other audio system calibration and setup routines. Since many techniques can also determine speaker distance (location), the present invention can be added to an existing system at little additional cost. A complete setup system with equalization, speaker distance measuring (for delay calibration) and polarity checking can be offered using many common hardware and software elements.

To make the system completely automatic, the polarity of each speaker circuit may be made adjustable at the receiver unit, such that when polarity reversal is detected, the system will detect such reversal when the calibration routine is executed, and the polarity of the corresponding speaker circuits reversed to correct reversed wiring at the speaker. This polarity correction can take the form of a physical switching element, or may be achieved through hardware or software means, by adjusting phase or timing of the audio output signals.

While described herein as being used in a home theater system, the present invention may also be used in other types of audio systems, including, but not limited to, commercial audio, home stereo, car audio, outdoor audio, and the like.

In addition, while the method of detecting the impulse response of the system is illustrated here in the preferred embodiment as an adaptive filtering system, other types of systems for detecting impulse response may be used within the spirit and scope of the present invention. Impulse response can be measured using one of a variety of known techniques in the art. Impulse response can also be determined using one of the novel techniques developed in part by the inventor of the present application, as set forth in the co-pending parent Patent Applications previously incorporated by reference.

While the preferred embodiment and various alternative embodiments of the invention have been disclosed and described in detail herein, it may be apparent to those skilled in the art that various changes in form and detail may be made therein without departing from the spirit and scope thereof.

We claim:

1. A method for determining speaker polarity in an audio system, comprising:
generating an audio test signal,
filtering the audio test signal,
receiving the audio test signal output from a speaker to a signal detector,
determining the impulse response of the audio system from the audio test signal and the received audio test signal to detect the polarity of an initial impulse in a system impulse response; and
determining speaker polarity from the polarity of the initial impulse of the system impulse response.

2. The method of claim 1, wherein the audio test signal comprises a digital audio test signal, the method further comprising:
converting the digital audio test signal to an analog audio signal, and
outputting the analog audio signal from the speaker.

3. The method of claim 2, wherein the signal detector comprises a microphone placed at a predetermined location.

4. The method of claim 2, further comprising:
converting the received audio test signal to a received digital audio test signal prior to determining the impulse response of the system.

5. The method of claim 1, wherein determining impulse response of the system comprises filtering, using an adaptive filter, the audio signal and the received audio signal to detect the polarity of an initial impulse in a system impulse response.

6. The method of claim 1, wherein generating an audio test signal comprises generating a predetermined audio signal pattern including a noise burst from the speaker.

7. An apparatus for determining speaker polarity in an audio system, comprising:
an audio signal source for producing an audio test signal,
a filter for filtering the audio test signal to pass only predetermined frequencies of the audio test signal,
an audio output for receiving the audio test signal and providing an audio signal output from a speaker,
an audio input for receiving an audio signal from a microphone placed at the selected location,
an impulse response detection system, for determining the impulse response of the audio system from the audio test signal and the received audio signal, and
a processor for determining speaker polarity from the impulse response of the system.

8. The apparatus of claim 7, wherein the audio test signal comprises a digital audio test signal, the audio output further comprises:
a digital to analog converter for converting the digital audio test signal to an analog audio test signal prior to outputting the audio test signal from the speaker.

9. The apparatus of claim 7, wherein the audio input further comprises:
an analog to digital converter for converting the received audio test signal to a received digital audio test signal prior to determining the impulse response of the system.

10. The apparatus of claim 7, wherein determining impulse response of the system comprises filtering, using an adaptive filter, the audio test signal and the received audio signal to detect the polarity of an initial impulse in a system impulse response.

11. The apparatus of claim 8, wherein the digital audio test signal comprises a predetermined audio signal pattern including a noise burst.

12. A method for determining speaker polarity in an audio system, comprising:
generating an audio test signal,
receiving the audio test signal output from a speaker to a signal detector,
determining the impulse response of the system from the audio test signal and the received audio test signal,
filtering the impulse response; and
determining speaker polarity from the polarity of an initial impulse of the system impulse response.

13. The method of claim 12, wherein the audio test signal comprises a digital audio test signal, the method further comprising:
converting the digital audio test signal to an analog audio signal, and
outputting the analog audio signal from the speaker.

14. The method of claim 12, wherein the signal detector comprises a microphone placed at a predetermined location.

15. The method of claim 14, further comprising:
converting the received audio test signal to a received digital audio test signal prior to determining the impulse response of the system.

16. The method of claim 12, wherein determining impulse response of the system comprises filtering, using an adaptive filter, the audio signal and the received audio signal to detect the polarity of an initial impulse in a system impulse response.

17. The method of claim 12, wherein generating an audio test signal comprises generating a predetermined audio signal pattern including a noise burst from the speaker.

18. An apparatus for determining speaker polarity in an audio system, comprising:
an audio signal source for producing an audio test signal,
an audio output for receiving the audio test signal and providing an audio signal output from a speaker,
an audio input for receiving an audio signal from a microphone placed at the selected location,
an impulse response detection system, for determining the impulse response of the audio system from the audio test signal and the received audio signal,
a filter, for filtering the impulse response, and
a processor for determining speaker polarity from the impulse response of the system.

19. The apparatus of claim 18, wherein the audio test signal comprises a digital audio test signal, the audio output further comprises:
a digital to analog converter for converting the digital audio test signal to an analog audio test signal prior to outputting the audio test signal from the speaker.

20. The apparatus of claim 18, wherein the audio input further comprises:
an analog to digital converter for converting the received audio test signal to a received digital audio test signal prior to determining the impulse response of the system.

21. The apparatus of claim 18, wherein determining impulse response of the system comprises filtering, using an adaptive filter, the audio test signal and the received audio signal to detect the polarity of an initial impulse in a system impulse response.

22. The apparatus of claim 19, wherein the digital audio test signal comprises a predetermined audio signal pattern including a noise burst.

23. A method of determining speaker polarity in an audio system, comprising:
measuring an impulse response of the audio system,
filtering out a predetermined frequency range at least during or after measuring the impulse response of the audio system, and
determining polarity of a speaker in the audio system from a polarity of an initial pulse in the impulse response of the audio system.

24. The method of claim 23, wherein filtering comprises applying a filter to the impulse response of the audio system.

25. The method of claim 23, wherein filtering comprises applying a filter to a test signal used to determine impulse of the audio system.

26. The method of claim 23, wherein filtering comprises applying a filter to a received signal from an audio transducer used to receive a test signal from the speaker to determine the impulse response of the audio system.
